(19) United States
(12) Patent Application Publication
(10) Pub. No.: US 2026/0058787 A1
(43) Pub. Date: Feb. 26, 2026

(54) REDUCING INTER-UE INTERFERENCE IN COMMUNICATION SYSTEMS INCLUDING FULL-DUPLEX BASE STATIONS

(71) Applicant: Google LLC, MOUNTAIN VIEW, CA (US)

(72) Inventors: Jibing WANG, San Jose, CA (US); Erik STAUFFER, Sunnyvale, CA (US)

(21) Appl. No.: 19/104,917

(22) PCT Filed: Aug. 3, 2023
(86) PCT No.: PCT/US2023/029379

§ 371 Date: Feb. 19, 2025

Related U.S. Application Data
(60) Provisional application No. 63/374,791, filed on Sep. 7, 2022.

(51) Int. Cl. H04L 5/14; H04L 5/00; H04L 5/16

(52) U.S. Cl. CPC H04L 5/1461; H04L 5/0037; H04L 5/16

(57) ABSTRACT

A method for reducing inter-user equipment (UE) interference in a communication system that includes a full-duplex base station. A method performed by the full-duplex base station includes selecting a first UE and a second UE as a half-duplex pair, the first UE and the second UE generating an inter-UE interference that achieves a threshold criterion. The method then includes receiving a first uplink signal on a specific frequency from the first UE and transmitting a first downlink signal on the specific frequency to the second UE, with the first uplink signal and the first downlink signal at least partially overlapping in time.

### BACKGROUND

Current and future wireless communication systems (e.g., 5G and 6G) target faster transmissions and increased bandwidth. Additionally, these technologies are expected to continue a trend of supporting additional types of devices and services (e.g., machines, objects, and virtual and augmented reality). Technologies supporting these faster and more robust systems may include full-duplex communication, that is, bi-directional same frequency communication at the same, or overlapping, times.

However, full-duplex communication presents challenges in terms of interference, especially self-interference at the base station. Not only is self-interference a concern, but also cross-link interference between user equipment (UE), also referred to as inter-UE interference. It, therefore, is desirable to reduce inter-UE interference when implementing full-duplex communication in wireless systems.

### SUMMARY

This disclosure provides techniques for reducing inter-UE interference in communication systems, including full-duplex base stations (BS). According to an aspect, a full-duplex base station may select a first UE and a second UE as a half-duplex pair, i.e., a pair of half-duplex UEs which transmit and receive on the same frequency, respectively, during an overlapping time period. When communicating with a half-duplex pair, the full-duplex base station receives an uplink signal on a frequency from the first UE, and transmits a downlink signal to a second UE on the same frequency simultaneously, e.g., in the same resource block (RB) or in different RBs that overlap in time. Using various techniques, the full-duplex base station selects the half-duplex pair so inter-UE interference is below a threshold.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 illustrates an example operating environment for embodiments;

FIG. 2 illustrates an example device diagram of network entities that can implement various aspects of inter-UE interference reduction;

FIG. 3 illustrates an example operating environment featuring blockers and an adaptive phase-changing device;

FIG. 4A illustrates an example communication scenario including UEs susceptible to inter-UE interference;

FIG. 4B illustrates an example communication scenario involving a half-duplex pair using a blocker to reduce inter-UE interference according to an embodiment;

FIG. 4C illustrates an example communication scenario involving a different half-duplex pair reducing inter-UE interference according to an embodiment;

FIG. 5 illustrates an example signaling and control diagram between a base station, first and second APDs, and first and second UEs, that reduces inter-UE interference according to an embodiment illustrated in FIGS. 4A-4C;

FIG. 6 illustrates an example communication scenario involving a half-duplex pair using a blocker to reduce inter-UE interference from another UE communicating with another base station according to an embodiment;

FIG. 7 illustrates an example signaling and control diagram between first and second base stations, first and third APDs, and first and third UEs, that reduces inter-UE interference according to an embodiment illustrated in FIG. 6;

FIG. 8 illustrates an example method at a full-duplex base station for reducing inter-UE interference in a communication system according to an embodiment; and

FIG. 9 illustrates an example method at a UE for reducing inter-UE interference according to an embodiment.

### DETAILED DESCRIPTION

As described in the Background section, introducing full-duplex base stations into new generations of radiocommunication systems creates interference challenges. Techniques presented below reduce inter-user equipment interference in a communication system that includes a full-duplex base station. Optionally, these techniques may incorporate adaptive phase-changing devices and blockers to reduce inter-UE interference.

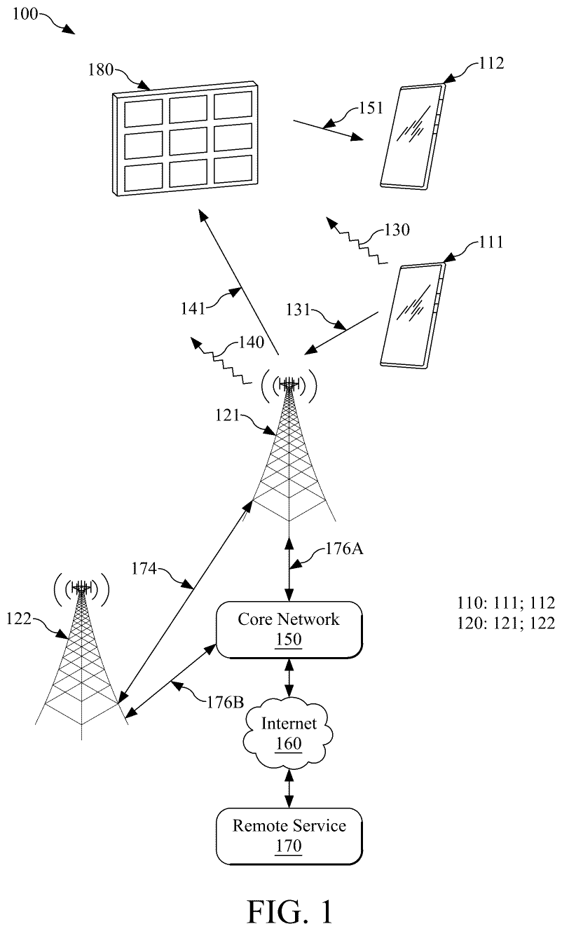

FIG. 1 illustrates an example operating environment 100 for embodiments. User-equipment (UE) 110 (shown as first UE 111 and second UE 112) communicates with one or more base stations 120 (illustrated as first base station 121 and second base station 122) through one or more communication links (illustrated as uplink signal 130 and downlink signal 140 having various signal components described below). The use of arrows in the Figures to illustrate radio signals is not intended to reflect any particular signal energy pattern and can be, e.g., narrow beam, wide beam, omnidirectional, etc. Thus, uplink signal 130 will have various signal components/energy emanating in various directions including a signal component 131 which is incident on base station 121 and, similarly, downlink signal 140 will have various signal components/energy emanating in various directions including a signal component 141 which is incident on an adaptive phase-changing device (APD) 180.

APD 180 generally includes a configurable surface (e.g., a Reconfigurable Intelligent Surface (RIS)) that shapes how signals striking the configurable surface are reflected (e.g., with respect to phase, amplitude, and/or polarization). In this discussion, the incident signal component 141 that strikes an APD 180 is distinguished from a reflected signal 151 that has struck the APD 180 for the sake of explanation and not by way of limitation. References to an “uplink signal” and a “downlink signal” may be understood by one of ordinary skill in the art to include reflected signals unless the context indicates otherwise.

In an embodiment, the base stations 120 are full-duplex base stations and the UEs are half-duplex. For example, the first base station 121 receives incident uplink signal 131 from the first UE 111 on a frequency and transmits downlink signal 140 ultimately to the second UE 112 on the same frequency.

For simplicity, UEs 110 are illustrated as smartphones but each can be implemented as any suitable electronic device. For example, a UE 110 can be implemented as a mobile communication device, a modem, a cellular phone, a gaming device, a navigation device, a media device, a laptop computer, a desktop computer, a tablet computer, a smart appliance, or an Internet-of-Things (IoT) device.

The base stations 120 (e.g., Evolved Universal Terrestrial Radio Access Network Node B (E-UTRAN Node B or eNB), Next Generation Node B (gNB), or future evolutions and the like) may each be implemented in a microcell, small cell, picocell, distributed base stations, and the like, or a combination thereof. Multiple base stations 120 (e.g., first base station 121 and second base station 122) constitute a Radio Access Network and communicate with each other over an interface 174 (e.g., an Xn or X2 interface). Base stations 120 connect with a core network 150 over interfaces 176A, 176B (e.g., an NG/NG3 interface and/or SI interface). UEs 110 connect, via the core network 150, to public networks, such as the Internet 160, to interact with a remote service 170.

The base stations 120 communicate with the UEs 110 via uplink signals 130 and downlink signals 140, which can be implemented as any suitable type of wireless link. The uplink signals 130 and downlink signals 140 include control-plane information and/or user-plane data. The uplink signals 130 and downlink signals 140 may include one or more wireless links (e.g., radio links) or radio bearers implemented using any appropriate communication protocol or standard, or a combination thereof (e.g., 3rd Generation Partnership Project Long-Term Evolution (3GPP LTE), Fifth Generation New Radio (5GNR), 6G, etc.). In some cases, uplink signals 130 and downlink signals 140 may be aggregated or coordinated.

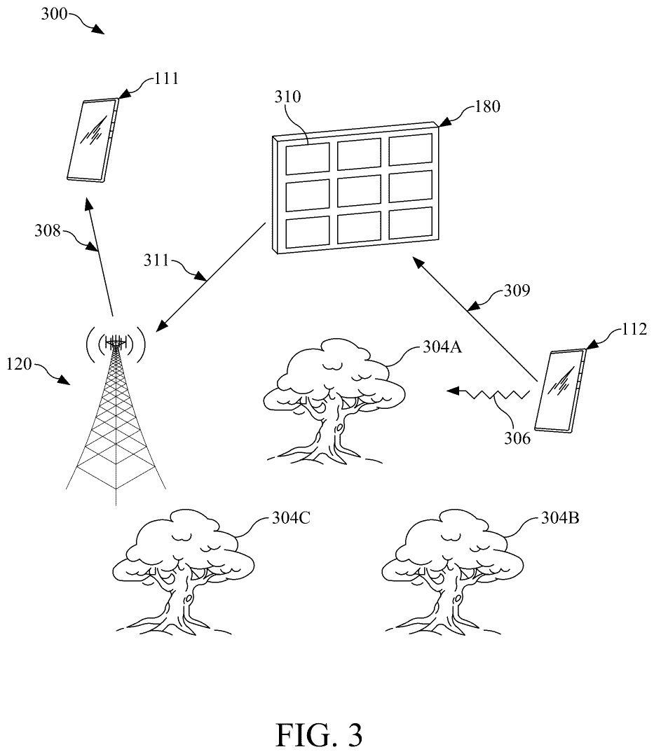

If an APD 180 is utilized, the APD 180 reflects incident uplink signals as a reflected uplink signal (not shown in FIG. 1, see FIG. 3) and/or the APD 180 reflects incident downlink signals 141 as a reflected downlink signal 151. The reflected downlink signal 151 corresponds to the incident downlink signal 141. In some embodiments, one or more base stations 120 configure aspects of the APD 180, such as the configurable surface of the APD 180 and the timing and dimensions of RIS changes.

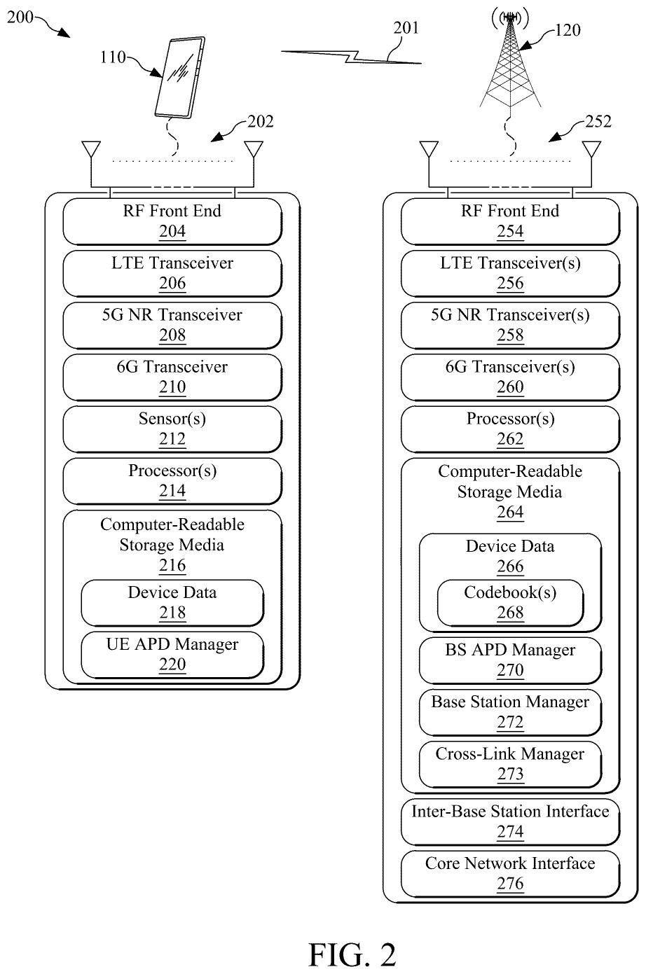

FIG. 2 illustrates an example device diagram 200 of network entities that can implement various aspects of inter-UE interference reduction. More specifically, the device diagram describes an example UE 110 and an example base station 120. UEs 110 or base stations 120 may include additional functions and interfaces omitted from FIG. 2 in the interest of brevity. Signals 201 represent the previously described uplink signals 130 and downlink signals 140.

The UE 110 includes antennas 202, a radio frequency (RF) front end 204, and RF transceivers that have at least one of an LTE transceiver 206, a 5G NR transceiver 208, or a 6G transceiver 210 for communicating with base stations 120. The antennas 202 and the RF front end 204 are tuned to one or more frequency bands, e.g., as may be defined by 3GPP LTE, 5G NR, and 6G communication standards and implemented by the LTE transceiver 206, the 5G NR transceiver 208, and/or the 6G transceiver 210. The antennas 202, RF front end 204, and RF transceivers 206, 208, and 210 can be configured to support beamforming and, more generally, can be narrow beam, wide beam, or omnidirectional.

The UE 110 includes sensors 212, processor(s) 214, and computer-readable storage media (CRM) 216. Sensors 212 can include at least one of accelerometers, gyros, depth sensors, distance sensors, temperature sensors, thermistors, battery sensors, or power usage sensors. The processor(s) 214 can include single or multiple-core processors, and the CRM 216 excludes propagating signals and includes any suitable memory/storage. For example, memory/storage can include random-access memory (RAM), static RAM (SRAM), dynamic RAM (DRAM), non-volatile RAM (NVRAM), read-only memory (ROM), and/or flash memory useable to store device data 218 of the UE 110. The device data 218 of the UE stores instructions executable by processor(s) 214 to facilitate user-plane communication, control-plane signaling, and user interaction with the UE 110.

Optionally, the CRM 216 may store UE APD manager 220, which may additionally or alternatively be implemented using hardware logic or circuitry of the UE 110. UE APD manager 220 may analyze link quality parameters and request utilization of an APD 180 in communicating with a base station 120 and may control the configuration of a RIS of the APD 180.

The base station 120 is illustrated as a single, integrated network node (e.g., a gNode B). However, the functionality of the base station 120 may be distributed across multiple entities such as a Central Unit (CU), Distributed Unit (DU), and/or Radio Unit (RU). In FIG. 2, base station 120 includes antennas 252, an RF front end 254, and RF transceivers that include at least one of an LTE transceiver 256, a 5G NR transceiver 258, or a 6G transceiver 260 for communicating with UEs 110. The antennas 252 and the RF front end 254 can be tuned to one or more frequency bands, e.g., as may be defined by 3GPP LTE, 5G NR, and 6G communication standards and implemented by the LTE transceiver 256, the 5G NR transceiver 258, and/or the 6G transceiver 260. The antennas 252, RF front end 254, and RF transceivers 256, 258, and 260 can be configured to support beamforming.

The base station 120 includes processor(s) 262 and computer-readable storage media (CRM) 264. The processor(s) 262 can include single or multiple-core processors, and the CRM 264 excludes propagating signals and includes any suitable memory/storage. For example, memory/storage can include random-access memory (RAM), static RAM (SRAM), dynamic RAM (DRAM), non-volatile RAM (NVRAM), read-only memory (ROM), and/or Flash memory useable to store device data 266 of the base station 120. The device data 266 of the base station includes network scheduling data, radio resource management data, applications, and/or an operating system of base station 120, which are executable by the processor(s) to enable communication with the UE 110. The device data 266 may include codebook(s) 268, such as surface-configuration codebook(s) that store surface-configuration information for a RIS of an APD 180.

Surface-configuration codebook(s) can include phase vector information and/or beam configuration information. Codebook(s) 268 can include a phase sweeping codebook indicating phase-sweeping patterns.

The CRM 264 includes a base station APD manager 270, a base station manager 272, and a cross-link manager 273, which can each additionally or alternatively be implemented using hardware logic or circuitry of the base station 120. The base station APD manager 270 manages APD usage in communicating with the UE 110 and determines surface configurations for the APD (e.g., RIS configurations) based on, e.g., link quality parameters. The base station APD manager 270 can receive an indication from a UE 110 to request utilization of an APD 180 and/or to perform a surface reconfiguration and can determine position configurations for the APD. The base station manager 272 configures the RF transceivers 256, 258, and 260 for communication with the UE 110, APD 180, other base stations 121, 122, and/or communication with the core network 150.

The base station 120 includes an inter-base station interface 274 and a core-network interface 276. The inter-base station interface 274 can be an interface, such as an Xn and/or X2 interface, which the base station manager 272 configures to exchange user-plane and control-plane data with another base station 120, to manage the communication of the base stations 120 with the UE 110. The core-network interface 276 can be configured by the base station manager 272 to exchange user-plane data and control-plane information with core network functions and/or entities.

FIG. 3 illustrates an example operating environment 300 featuring blockers 304 and an adaptive phase-changing device 180. One or more blockers 304 (e.g., 304A, 304B, 304C) interfere with communication between base station 120, and UE 112. For simplicity, blockers 304 are illustrated as foliage that blocks direct (e.g., line-of-sight) uplink signal component 306 between base station 120 and UE 112. However, blockers 304 can take many forms, including buildings, walls, vehicles, water vapor, people, and other objects. Blockers 304 may be stationary (e.g., a building) or moving (e.g., a vehicle). In this particular example, UE 111 receives an unblocked incident uplink signal component 308.

To overcome the problem of blockers 304 blocking a direct uplink signal component 306, FIG. 3 illustrates the use of APD 180 to reflect an equivalent signal 309. For example, the APD 180 may include a RIS 310 that reflects equivalent signal 309 from UE 112 thereby creating reflected uplink signal 311 that is transmitted to base station 120, avoiding blocker 304. The RIS 310 of the APD 180 may be controlled by configuring a phase vector of the APD 180 for communication between the base station 120 and the UE 112.

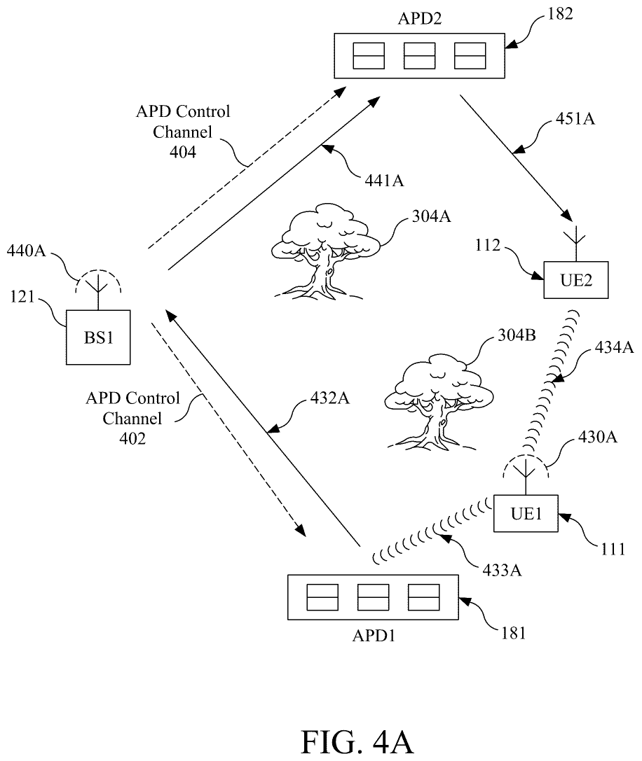

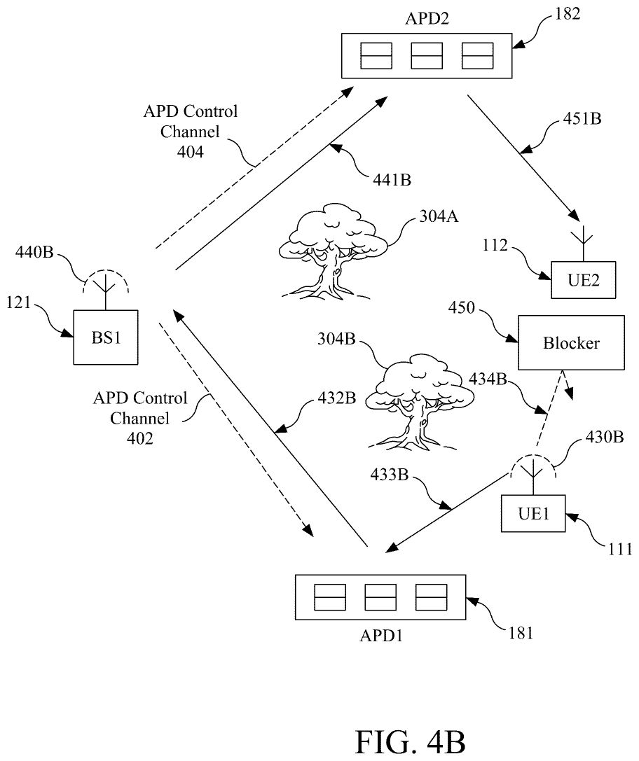

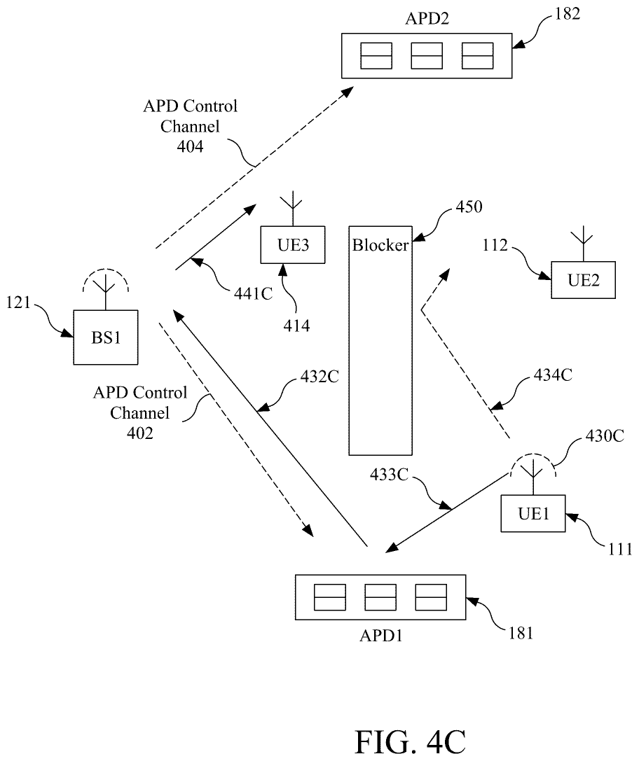

FIGS. 4A to 4C illustrate various communication scenarios in operating environments the same as or similar to those shown in FIGS. 1 and 3. However unlike the scenario illustrated in FIG. 3, rather than just avoiding blockers 304, one or more blockers 304 can be used to reduce inter-UE interference. In the various scenarios, APDs 180 and/or blockers 304 may be used independently or in combination to reduce inter-UE interference in a communication system that includes a full-duplex base station.

FIG. 4A illustrates an example communication scenario including UEs susceptible to inter-UE interference. A first UE 111 and a second UE 112 are in communication with a first base station 121.

Trees (e.g., 304A, 304B) act as blockers 304 that block direct signal energy transmission from base station 121 to UE 112 in the downlink and from UE 111 to base station 121 in the uplink. However, APDs 180 (illustrated as a first APD 181 and a second APD 182) reflect signal energy so as to avoid the blockers 304. Base station 121 configures the APDs 181 and 182 using APD control channels 402,404.

The base station 121 indirectly receives an uplink signal 430A on a frequency from the first UE 111 and transmits a downlink signal 440A on the frequency (i.e., the same carrier frequency) to a second UE 112. More specifically, the base station 121 receives, from the first UE 111, a reflected uplink signal 432A reflected by a first APD 181 from an incident portion 433A of omnidirectional uplink signal 430A of the first UE 111. The omnidirectional uplink signal 430A includes signal energy which radiates in part 433A toward the first APD 181 and in part 434A toward UE 112 (as well as in other directions). The base station 121 transmits, to the second UE 112, an incident downlink signal 441A that is reflected by a second APD 182 as a reflected downlink signal 451A received by the second UE 112. The transmitting and receiving by the base station 121 at least partially overlap in time and are performed on the same carrier frequency.

The temporally overlapping communications on the same frequency generate inter-UE interference energy 434A negatively affecting the receipt of the reflected downlink signal 451A by the second UE 112. More specifically, the transmission of the omnidirectional uplink signal 430A by the first UE 111 generates interference energy 434A received by the second UE 112 while it is receiving the reflected downlink signal 451A on the same frequency. Interference energy 434A may be significant so as to disrupt or prevent recovery of the transmitted information, by the second UE 112, from the received reflected downlink signal 451A.

FIG. 4B illustrates an example communication scenario involving a half-duplex pair using a blocker 304 to reduce inter-UE interference according to an embodiment. The base station 121 selects the first UE 111 and the second UE 112 as a half-duplex pair to communicate with the base station 121 using the same carrier frequency in the uplink and the downlink, respectively. For example, the first UE 111 and the second UE 112 may be assigned resources (e.g., a frequency domain resource assignment associated with a single carrier frequency) for transmission and/or reception.

The base station 121 receives a portion of an omnidirectional uplink signal 430B on a frequency from the first UE 111. More specifically, the base station 121 receives, from the first UE 111, a reflected uplink signal 432B reflected by the first APD 181 from an incident uplink signal 433B of the first UE 111.

The base station 121 transmits a downlink signal 440B on the frequency (i.e., the same frequency as that used for the uplink signal 430B) to the second UE 112, the uplink signal 430B and the downlink signal 440B at least partially overlapping in time. That is, the second UE 112 receives the downlink signal on the frequency. More specifically, the base station 121 transmits, to the second UE 112, an incident downlink signal 441B that is reflected by the second APD 182 as a reflected downlink signal 451B received by the second UE 112 at a time at least partially overlapping the time when the base station 121 receives the reflected uplink signal 432B.

In an embodiment, the base station 121 assigns a same resource block for receiving the uplink signal 430B and transmitting the downlink signal 440B. In another embodiment, the base station 121 assigns different resource blocks with overlapping slot allocations for receiving the uplink signal 430B and transmitting the downlink signal 440B.

As with the scenario of FIG. 4A, the temporally overlapping communications on the same frequency in the scenario of FIG. 4B have the potential for generating interference energy 434B in the direction of UE2 112. However, in this example, the interference energy 434B is partially or completely blocked by blocker 450, resulting in lower interference with respect to signal 451B's reception by UE 112 than would have occurred if blocker 450 was not present.

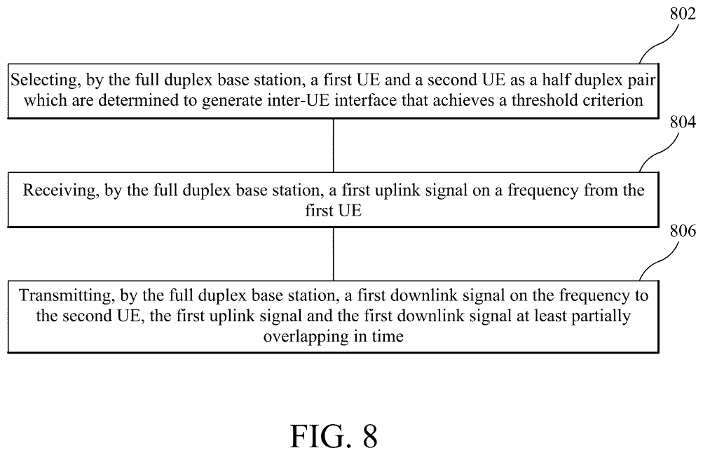

The base station 121 selects the first UE 111 and the second UE 112 as the half-duplex pair by determining that inter-UE interference achieves a threshold criterion. This will be explained in further detail with reference to FIG. 8.

FIG. 4C illustrates an example communication scenario involving the base station changing a half-duplex pairing to reduce inter-UE interference according to an embodiment.

Consider that, as discussed above with reference to FIG. 4B, blocker 450 was initially located between the first UE 111 and the second UE 112 and that base station 121 selected the first UE 111 and the second UE 112 as a half-duplex pair. However at a later time, shown in FIG. 4C, the blocker 450 changed its location relative to its earlier position illustrated in FIG. 4B. This change in blocker 450 location can reflect different use cases. For example, the change may be due to movement of a same blocker 450 from one location to another. Such movement may occur, e.g., when a blocker moves relative to UEs. For example, in the case of a vehicle as a blocker 450, movement may occur when the vehicle moves relative to the UEs. As another example, the change may be due to replacement of a blocker 450 with another blocker 450. Such replacement may occur, e.g., when UEs move relative to blockers. For example, in the case of UEs moving on a train relative to buildings serving as blockers 450, the change may occur when the UEs on the train move relative to the buildings.

The number of different objects that could function as blockers is large, as is the number of different reasons for change in blocker locations. As but one additional example, a blocker 450 could be a fan. Blades of the fan can serve as blockers 450 that circulate and thus move, while the main housing of the fan may also serve as a blocker 450 that does not move. In view of the many different possible embodiments and blocker/UE movement scenarios, the disclosure should not be limited to the examples given herein.

In FIG. 4C, the base station 121 deselected the first UE 111 and the second UE 112 as a half-duplex pair; and these two UEs 111, 112 therefore, do not transmit and receive on the same frequency at the same time. The base station 121′s deselection of these two UEs as a half-duplex pair can, for example, occur in response to receipt of a measurement report from UE 112 indicating a rise in the level of interference caused by the uplink transmissions of UE 111. Instead, at the time illustrated in FIG. 4C, the base station 121 selects the first UE 111 and a third UE 414 as the half-duplex pair and are in communication with the base station 121. The base station 121 receives an uplink signal (e.g., reflected uplink signal 432C) on a frequency from the first UE 111, and transmits a downlink signal 441C on the same frequency to the third UE 114, with the uplink signal 430C and the downlink signal 441C at least partially overlapping in time. This new half-duplex pairing can, for example, be the result of the base station 121's knowledge of the relative positions of the first UE 111, the third UE 414, and the blocker 450. Alternatively, any of the techniques described below with respect to FIG. 8 for half-duplex pairing selection can be used when re-selecting half-duplex pairs due, e.g., to changing interference conditions.

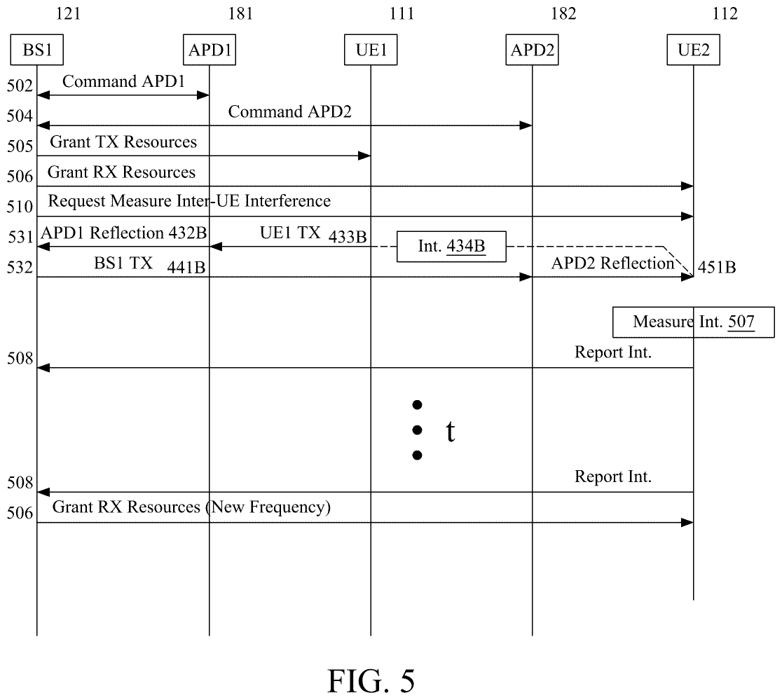

FIG. 5 illustrates an example signaling and control diagram between a base station 121, first and second APDs 181, 182, and first and second UEs 111, 112, in accordance with aspects of reducing inter-UE interference according to an embodiment. The base station 121, the first and second APDs 181, 182, and the first and second UEs 111, 112 may be implemented in a manner similar to the entities described with reference to FIGS. 1-4C.

Optionally, if APDs are involved, the first base station 121 communicates 502, 504 with the first and second APDs 181, 182 to gain APD capabilities and/or to configure the APDs 181, 182 to desired phase vectors for reflection of signals. The first base station 121 communicates 505 with the first UE 111 to grant resources (e.g., transmission resources) to the first UE 111. The first base station 121 communicates 506 with the second UE 112 to grant resources to the second UE 112 (e.g., reception resources). The first base station 121 requests 510 the second UE 112 to measure inter-UE interference at a given frequency and time, e.g., associated with UE 111 transmitting on the uplink.

The first UE 111 transmits 531 an uplink signal 430B (having an incident signal component 433B) in accordance with the uplink transmission grant 505 that is reflected by the first APD 181 as a reflected uplink signal 432B and received by the base station 121. Transmission of uplink signal 433B by the first UE 111 can cause interference 434B, as discussed herein. The first base station 121 transmits 532 a downlink signal 441B that is reflected by the second APD 182 as a reflected downlink signal 451B that is received by the second UE 112.

The receiving of the downlink signal at 451B by UE 112 and the transmission of the uplink signal 430B by UE 111 are on the same frequency and at least partially overlap in time. Thus, the second UE 112 receives not only reflected downlink signal 451B, but also receives interference energy 434B caused by transmission of uplink signal 430B.

The second UE 112 estimates 507 (or otherwise measures) interference 434B in accordance with the inter-UE interference measurement request 510. The first base station 121 receives 508 a report of estimated interference measured at 507. The base station 121 can use the report of the estimated interference in multiple ways. For example, if the threshold criterion is achieved, no action may be taken for a duration t.

However consider that after the duration t, the UE2 112 conducts another measurement 507B and transmits another interference measurement report 508 to the first base station 121 which indicates that the second UE 112 is experiencing interference energy 434 which exceeds the threshold criterion. In that case, the first base station 121 may take action to mitigate this interference. For example, the estimated interference may be used to trigger deselection of the first UE 111 and the second UE 112 as the half-duplex pair (e.g., as described above with respect to FIG. 4C). As another example, the report of the estimated interference may be used to grant different resources (e.g., a different frequency) at 506 to the second UE 112, as depicted in FIG. 5.

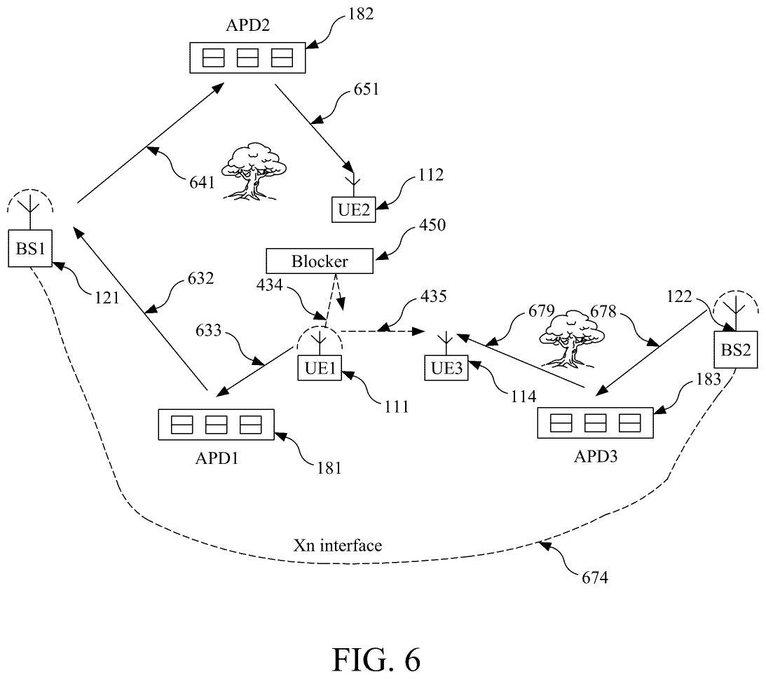

FIG. 6 illustrates an example communication scenario including a half-duplex pair using a blocker 450 to reduce inter-UE interference from another UE 614 communicating with a second base station 122 according to an embodiment. As with other embodiments, APDs 180 and/or blockers 450 may be used independently or in combination to reduce inter-UE interference in a communication system that includes a full-duplex base station.

As with the scenario shown in FIG. 4B, a first UE 111 and a second UE 112 have been selected as the half-duplex pair and communicate with the base station 121. The base station 121 receives an uplink signal 632, 633 on a frequency from the first UE 111 and transmits a downlink signal 641, 651 on the same frequency to the second UE 112, the uplink and downlink signals at least partially overlapping in time. Blocker 450 blocks, at least in part, the uplink signal transmitted by UE 111 (e.g., interference energy 434) from negatively affecting the receipt of the downlink signal at the second UE 112.

However, in FIG. 6, a third UE 114 receives a downlink signal 678, 679 from the base station 122. For example, the third UE 114 and the second base station 122 may be located in a cell that neighbors the cell in which the half-duplex pair of UEs 111, 112 and the first base station 121 are located. The third UE 114 receives a reflected downlink signal 679 reflected by third APD 183 from downlink signal 678 transmitted by the second base station 122.

Receipt of the reflected downlink signal 679) at the third UE 114 and transmission of the uplink signal 633, 632 by the first UE at least partially overlap in time. Further, reflected downlink signal 679 and uplink signal 633,632 are transmitted on the same frequency.

The temporally overlapping communications on the same frequency generate interference energy 435 that negatively affects the receipt of the reflected downlink signal 679 by the third UE 112. Interference energy 435 may be significant so as to disrupt or prevent receipt of the reflected downlink signal 679 by the third UE 114. As with the second UE 112, the third UE 114 can estimate an inter-UE interference level. The second base station 122 can request the third UE 114 to transmit to the second base station 122 the estimated-inter-UE interference level report.

The first base station 121 may negotiate with the second base station 122 how to manage the interference 435 with the reception of the reflected downlink signal 679 caused by the uplink signal 633, 632 of the first UE 111. The first and second base stations 121, 122 can negotiate interference management using Xn interface 674. For example, a new (a second) half-duplex pair may be selected by the first base station 121 as a result of the negotiation, the second half-duplex pair not including the UE 110 causing interference 435. As another example, the first base station 121 may command the first UE 111 to reduce a transmit power associated with a subsequent transmission of the first uplink signal 633.

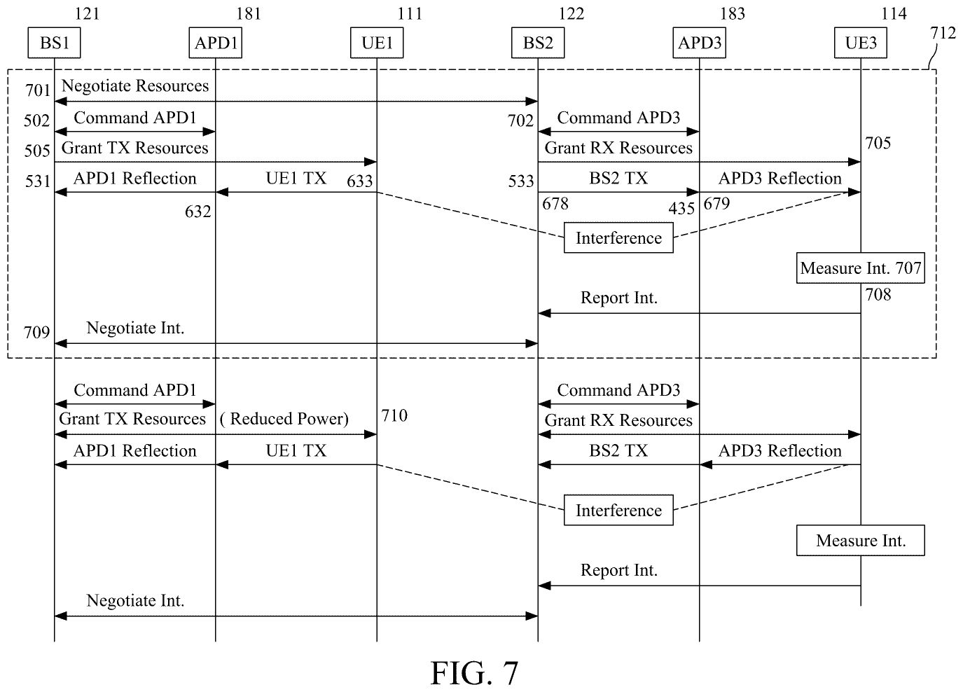

FIG. 7 illustrates an example signaling and control diagram between first and second base stations 121, 122, first and third APDs 181, 183, and first and third UEs 111, 114 in accordance with aspects of reducing inter-UE interference according to the embodiment of FIG. 6. The first and second base stations 121, 122, the first and third APDs 181, 183, and the first and third UEs 111, 113 may be implemented in a manner similar to the entities described with reference to FIGS. 1-6.

The first base station 121 communicates 701 with the second base station 122 to negotiate time/frequency resources for interference measurements. Optionally, the first base station 121 communicates 502 with the first APD 181 to gain APD capabilities and/or configure phase vectors, and the second base station 122 communicates with the third APD 183 to gain APD capabilities and/or configure phase vectors at 702.

The first base station 121 communicates with the first UE 111 to grant resources (e.g., uplink transmission resources) to the first UE 111. The second base station 122 communicates with the third UE 114 to grant resources (e.g., downlink reception resources) to the third UE 114. The second base station 122 may also command the third UE 114 to measure interference, e.g., on the frequency associated with the uplink transmission resources granted to the first UE 111.

The first UE 111 transmits an incident uplink signal 633 in the assigned uplink transmission resources that is reflected by the first APD 181 as a reflected uplink signal 632 and received by the first base station 121. Transmission of uplink signal 633 by the first UE 111 can cause interference 435 for the third UE 114 communicating with the second base station 122, as discussed more herein.

The second base station 122 transmits 533 an incident downlink signal 678 that is reflected by the third APD 183 as a reflected downlink signal 679 that is received by the third UE 114. First and third UEs 111, 114 and first and second base stations 121, 122 may be located such that transmission of uplink signal 633 by the first UE 111 to the first base station 121 may cause interference 435 for the third UE 114 receiving a downlink signal from the second base station 122.

The third UE 114 measures 707 interference 435. The second base station 122 receives 708 a report of estimated interference measured at 707. The first and/or second base stations 121, 122 can use the report of the estimated interference in a variety of ways, including taking no action, selecting a new half-duplex pair, or granting different resources to the first and/or third UEs 111, 114. The signaling 712 is repeated in the lower half of FIG. 7 in the same manner as described above (and therefore not further described here) except that, based on the negotiations 709 between the first base station 121 and the second base station 122, when the first base station 121 grants transmission resources to the first UE 111 via signal 710, it commands the UE to use reduced transmit power for UE 111's next uplink transmission (i.e., relative to the uplink transmit power associated with the grant transmitted via signal 505) in order to reduce the amount of interference energy 435 received by the third UE 114.

Embodiments can be described as methods. FIG. 8 illustrates an example method for reducing inter-UE interference in a communication system that includes a full-duplex base station according to an embodiment. The full-duplex base station and UEs may be implemented in a manner similar to the entities described with reference to FIGS. 1-7.

The method includes at operation 802, selecting, by a full-duplex base station, a first UE and a second UE as a half-duplex pair which are determined to generate inter-UE interference that achieves a threshold criterion.

For example, the threshold criterion can be that interference is below a specified interference level. In an embodiment, the second UE 112 can estimate an inter-UE interference level, e.g., by estimating the interference energy relative to the downlink signal. For example, BS 121 can request that UE 112 make interference measurements at one or more times when UE 111 is transmitting and at one or more times when UE 111 is not transmitting to enable a comparison that provides an estimate of how much interference UE 111's uplink transmission is causing to UE 112's downlink reception. The threshold criterion can, for example, be that the SINR gap with/without inter-UE interference is less than 2 dB. The SINR gap with/without inter-UE interference depends on whether there is a blocker 304, 450 between the UEs, the direction of the useful signal and the interference signal due to the presence/utilization of an APD 180.

The location of UEs 111 and 112 may also be used as part of the decision by base station 121 to select the first UE 111 and the second UE 112 as the half-duplex pair. The location of the first UE 111 and the second UE 112 can be determined using at least one of a global positioning system (GPS) indication, a downlink positioning reference signal (PRS) indication, or an uplink sounding reference signal (SRS) indication. The location of the UEs can be absolute, e.g., via GPS/latitude-longitude or relative to each other (or to the base station.) The location of a blocker 304, 450 can also be a factor in the base station's selection of two UEs as a half-duplex pair. For example, the first UE 111 and the second UE 112 may be selected based on their location relative to the location of the blocker 304, 450, e.g., the blocker 450 can be in between the two UEs, as illustrated in FIG. 4B. The absolute location of the blockers (for e.g., buildings/trees) can be determined based on high precision maps. The relative location of blockers with respect to a UE can be determined with beam sweeping, i.e., UE measured signal level can indicate if line of sight signal is present or not.

The base station 121 may use the location, size, and shape of the blocker 304 in selecting the first UE 111 and the second UE 112 as the half-duplex pair. For example, a blocker map may be accessed by base station 121. In an embodiment, the blocker map is created based on at least one of: radar sensing, a received signal received power, RSRP, indication, a received signal strength indicator, RSSI, indication, a reference signal received quality, RSRQ indication, or a signal to interference noise ratio, SINR, cellular indication. Radar sensing can directly detect blocker presence/location whereas the radio characteristics can be used to infer blocker presence/location, and this information is used to create a blocker map. The location of blocker 304 may then be determined from the blocker map.

The base station 121 can request the second UE 112 to transmit to the base station 121 the estimated inter-UE interference level and also request the other UE 111 to transmit its inter-UE interference level at a different time when the UE 111 is receiving and UE 112 is transmitting. In an embodiment, the request may include a timer configuration that instructs the UE to periodically estimate the interference level. The base station 121 receives an estimated inter-UE interference level report from the second UE 112. The selecting of the first UE 111 and the second UE 112 as the half-duplex pair may include picking the first UE 111 and the second UE 112 as having an estimated inter-UE interference level below the threshold criterion.

Additionally or alternatively, interference energy 434 that does not achieve the threshold criterion may trigger actions by the first UE 111 in an embodiment. For example, the base station 121 may command the first UE to reduce a transmit power associated with a subsequent transmission of the first uplink signal 131. As another example, the base station 121 may change the selection of the half-duplex pair such that UE 111 and/or UE 112 are paired with other UEs.

The method includes at operation 804, receiving, by the full-duplex base station, a first uplink signal on a frequency from the first UE. The method includes at operation 806, transmitting, by the full-duplex base station, a first downlink signal on the frequency to the second UE, the first uplink signal and the first downlink signal at least partially overlapping in time.

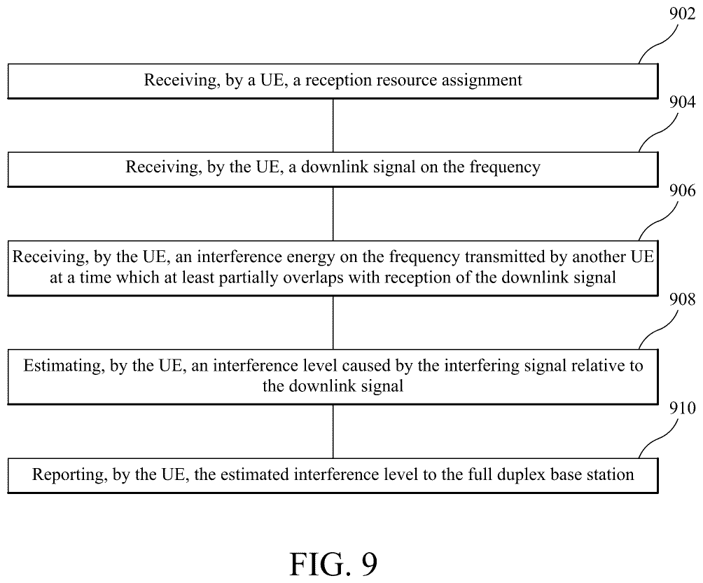

FIG. 9 illustrates an example method for reducing inter-UE interference according to an embodiment. The full-duplex base station and UEs may be implemented in a manner similar to the entities described with reference to FIGS. 1-7.

The method includes at operation 902, receiving, by a UE, a frequency domain resource assignment associated with a frequency. The method includes at operation 904, receiving, by the UE, a downlink signal on the frequency, and at operation 906 receiving, by the UE, interference energy transmitted by another UE on the same frequency. The method includes, at operation 908, estimating, by the UE, an interference level caused by the interfering signal relative to the downlink signal, and at operation 910, reporting, by the UE, the estimated inter-UE interference level to a full-duplex base station.

Although the features and elements of the present embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software or firmware tangibly embodied in a computer-readable storage medium for execution by a specifically programmed computer or processor.

In concluding, it is noted that references to the singular (e.g., “a” or “an”, “the”) should include the plural unless clearly indicated otherwise.

The term “and/or” is intended to include any combination of the terms “and” and “or.” For example, “A and/or B” may be understood to mean any combination including “A, B, or A and B.” The terms “and” and “or” may be used in the conjunctive or disjunctive sense and may be understood to be equivalent to “and/or.”

The construction “at least one of A or B” (e.g., A, B, or C) should be interpreted as any combination including A and/or B, including “A,” “B,” “A+A,” “B+B,” and “A+B.” The same reference numbers in different drawings identify the same or similar elements.

Reference throughout the specification to “one embodiment” or “an embodiment” means that a particular feature, structure or characteristic described in connection with an embodiment is included in at least one embodiment of the present invention. Thus, the appearances of the phrases “in one embodiment” or “in an embodiment” in various places throughout the specification are not necessarily all referring to the same embodiment. Further, the particular features, structures or characteristics may be combined in any suitable manner in one or more embodiments.

Note that numerical adjectives “first”, “second”, and “third” do not imply any order (are not ordinals) but are markers to distinguish separate instances of similar elements.

While various aspects and embodiments have been disclosed herein, other aspects and embodiments will be apparent to those skilled in the art. The various aspects and embodiments disclosed herein are for purposes of illustration and are not intended to be limiting.

1-14. (canceled)

15. A method performed by a full-duplex base station for reducing inter-user equipment, UE, interference in a communication system, the method being characterized by:
selecting a first UE and a second UE as a first half-duplex pair, the first UE and the second UE so that an inter-UE interference due to communications of the first UE and the second UE achieves a threshold criterion;
receiving, from the first UE, a first uplink signal on a frequency; and
transmitting, to the second UE, a first downlink signal on the frequency, the first uplink signal and the first downlink signal at least partially overlapping in time, at least one of the first uplink signal and the first downlink signal being reflected by an adaptive phase-changing device, APD.

16. The method of claim 15, further comprising:
determining a location of the first UE and a location of the second UE using at least one of a global positioning system, GPS, indication, a downlink positioning reference signal, PRS, indication, or an uplink sounding reference signal, SRS, indication,
wherein the selecting of the first UE and the second UE as the first half-duplex pair is based on the location of the first UE and the location of the second UE.

17. The method of claim 15, further comprising:
determining a location of a blocker between the first UE and the second UE, the blocker being stationary or slow moving relative to durations of the first uplink signal and the first downlink signal traveling time,
wherein the selecting of the first UE and the second UE as the first half-duplex pair uses the location of the blocker.

18. The method of claim 17, further comprising:
creating a blocker map based on at least one of radar sensing, a received signal received power, RSRP, indication, a received signal strength indicator, RSSI, indication, a reference signal received quality, RSRQ, indication, and a signal to interference noise ratio, SINR, cellular indication, wherein the location of the blocker is determined from the blocker map.

19. The method of claim 15, wherein the selecting of the first UE and the second UE as the first half-duplex pair includes configuring a phase vector of the APD.

20. The method of claim 19, wherein the phase vector is selected to minimize the inter-UE interference.

21. The method of claim 15, further comprising:
reflecting another of the first uplink signal and the first downlink signal using another APD.

22. The method of claim 21, wherein the selecting of the first UE and the second UE as the first half-duplex pair includes configuring a first phase vector of the APD, and a second phase vector for the other ADP.

23. The method of claim 22, wherein the first phase vector and the second phase vector are selected to minimize the inter-UE interference.

24. The method of claim 15, wherein the selecting of the first UE and the second UE as the first half-duplex pair comprises:
requesting the second UE to report an estimated inter-UE interference level;
receiving, from the second UE, the estimated inter-UE interference level; and
the selecting includes picking the first UE and the second UE so that the estimated inter-UE interference level is below a threshold.

25. The method of claim 24, further comprising:
directing the first UE to reduce a transmit power associated with a subsequent transmission of the first uplink signal.

26. The method of claim 15, further comprising:
negotiating, with an other full-duplex base station connected to a second half-duplex pair made of the first UE and a third UE, to avoid an interference caused by overlapping signals transmitted by at least two among the full-duplex base station, the first UE, the second UE, and the third UE.

27. The method of claim 26, wherein the negotiating includes exchanging information on location of the first UE, the second UE, and the APD, and on a current phase vector configuring the APD.

28. The method of claim 15, further comprising:
assigning a same resource block for the receiving of the first uplink signal and the transmitting of the first downlink signal.

29. The method of claim 15, further comprising:
assigning different resource blocks with overlapping slot allocation for the receiving of the first uplink signal and the transmitting of the first downlink signal.

30. The method of claim 15, further comprising:
estimating the inter-UE interference, wherein the selecting is based on a result of the estimating.

31. A method performed by a user equipment, UE, for reducing inter-UE interference, the method comprising:
receiving, from a full-duplex base station, a downlink signal on a frequency;
detecting interference energy due to an uplink signal transmitted, to the full-duplex base station, by another UE on the frequency during the receiving of the downlink signal;
estimating an inter-UE interference level based on the interference energy; and
reporting the estimated inter-UE interference level to the full-duplex base station,
wherein at least one of the uplink signal and the downlink signal is reflected by an adaptive phase-changing device, APD.

32. The method of claim 31, further comprising at least one of:
receiving, from the full-duplex base station, a reception resource assignment indicating the frequency;
receiving, from the full-duplex base station, a request to report the estimated inter-UE interference level.

33. The method of claim 32, wherein the request includes a timer value and instructs the UE to estimate the inter-UE interference level periodically, according to the timer value.

34. A base station apparatus, comprising:
at least one wireless transceiver;
a processor; and
computer-readable storage media comprising instructions, responsive to execution by the processor, making the base station apparatus to perform, using the at least one wireless transceiver, a method comprising:
selecting a first UE and a second UE as a first half-duplex pair, the first UE and the second UE so that an inter-UE interference due to communications of the first UE and the second UE achieves a threshold criterion;
receiving, from the first UE, a first uplink signal on a frequency; and
transmitting, to the second UE, a first downlink signal on the frequency, the first uplink signal and the first downlink signal at least partially overlapping in time, at least one of the first uplink signal and the first downlink signal being reflected by an adaptive phase-changing device, APD.
